(19) United States
(12) Patent Application Publication
(10) Pub. No.: US 2024/0021851 A1
(43) Pub. Date: Jan. 18, 2024

(54) HYDROGEN UTILIZATION SYSTEM

(71) Applicant: TOYOTA JIDOSHA KABUSHIKI KAISHA, Toyota-shi (JP)

(72) Inventors: Ryohei KATSUMATA, Toyota-shi (JP); Miyako SAKAI, Toyota-shi (JP); Tomio YAMANAKA, Nagoya-shi (JP); Mariko YAJIMA, Nagoya-shi (JP)

(73) Assignee: TOYOTA JIDOSHA KABUSHIKI KAISHA, Toyota-shi (JP)

(21) Appl. No.: 18/343,851

(22) Filed: Jun. 29, 2023

(30) Foreign Application Priority Data
Jul. 13, 2022 (JP) 2022-112470

(51) Int. Cl. H01M 8/04082; B60L 53/80; B60L 53/62

(52) U.S. Cl. CPC H01M 8/04201; B60L 53/80; B60L 53/62; H01M 2250/20

(57) ABSTRACT

A hydrogen utilization system includes: a hydrogen cartridge containing a hydrogen storage alloy; a first device configured in such a manner that the hydrogen cartridge is attachable to and detachable from the first device, the first device being operable using the hydrogen cartridge as an energy source; and a second device configured in such a manner that the hydrogen cartridge is attachable to and detachable from the second device, the second device being operable using the hydrogen cartridge as an energy source and being operable using another energy source.

### CROSS-REFERENCE TO RELATED APPLICATION

This application claims priority to Japanese Patent Application No. 2022-112470 filed on Jul. 13, 2022, incorporated herein by reference in its entirety.

### BACKGROUND

### 1. Technical Field

The technique disclosed herein relates to hydrogen utilization systems that utilize hydrogen as an energy source.

### 2. Description of Related Art

In recent years, increasing efforts have been made toward the Sustainable Development Goals (SDGs), and the realization of a hydrogen society that actively uses hydrogen that is a candidate for clean energy is one of such efforts. In this regard, Japanese Unexamined Patent Application Publication No. 2018-169225 (JP 2018-169225 A) describes a technique for storing hydrogen using a hydrogen storage alloy.

### SUMMARY

A large amount of hydrogen can be stored by using a hydrogen storage alloy. Therefore, for example, the cruising distance of a vehicle that uses hydrogen as an energy source can be increased by adopting a configuration in which hydrogen is stored in a hydrogen storage alloy. However, it is difficult to accurately grasp the amount of hydrogen remaining in a hydrogen storage alloy. In order to prevent a vehicle from running out of hydrogen, it is necessary to refuel the vehicle with hydrogen at a relatively early timing. As a result, hydrogen refueling is performed more frequently, and the use of the vehicle is limited by the amount of time required for the hydrogen refueling.

One possible solution is to place a hydrogen storage alloy in a cartridge that is attachable to and detachable from a vehicle. The use of such a hydrogen cartridge is particularly effective in small vehicles such as assisted bicycles and electric bicycles, and replacement of a hydrogen cartridge is simple and takes only a short time. Therefore, even if a hydrogen cartridge is replaced at a relatively early timing in order to prevent a vehicle from running out of hydrogen, the use of the vehicle will not be significantly limited. However, if a hydrogen cartridge is replaced at a relatively early timing, a relatively large amount of hydrogen remains in this used hydrogen cartridge. As a result, the hydrogen cartridge is refilled with hydrogen before all of the hydrogen in the hydrogen cartridge is used up, resulting in additional waste.

The present disclosure is not only used in vehicles that use hydrogen as an energy source, but also widely used in hydrogen utilization systems that use hydrogen as an energy source. The present specification provides a novel useful technique for hydrogen utilization systems that use a hydrogen cartridge.

The technique disclosed herein is embodied as a hydrogen utilization system. A first aspect provides a hydrogen utilization system. This hydrogen utilization system includes: a hydrogen cartridge containing a hydrogen storage alloy; a first device configured in such a manner that the hydrogen cartridge is attachable to and detachable from the first device, the first device being operable using the hydrogen cartridge as an energy source; and a second device configured in such a manner that the hydrogen cartridge is attachable to and detachable from the second device, the second device being operable using the hydrogen cartridge as an energy source and being operable using another energy source.

In the above configuration, the hydrogen cartridge containing the hydrogen storage alloy can be used in both the first device and the second device. At least the second device can operate not only with the hydrogen cartridge but also with the other energy source. According to such a configuration, the hydrogen cartridge can first be used for the first device, and can be replaced at any desired timing. This replacement timing may be a relatively early timing in order to avoid the first device running out of hydrogen. The used hydrogen cartridge of the first device can then be attached to the second device for reuse. Even if the supply of hydrogen from the hydrogen cartridge is unintentionally cut off, the second device can continue to operate with the other energy source. Therefore, the second device can continue to use the hydrogen cartridge until the amount of hydrogen remaining in the hydrogen cartridge becomes zero.

In the first aspect, the first device may be a mobility device, and the second device may be a non-mobility device. According to such a configuration, in the case where the first device is, for example, a small vehicle that uses hydrogen as an energy source, the use of the vehicle will not be significantly limited even if the hydrogen cartridge is replaced at a relatively early timing in order to prevent the vehicle from running out of hydrogen. As used herein, the “mobility device” broadly means a device capable of moving in at least one of the following environments: on the ground, underground, on water, underwater, in the air, and in space, such as vehicles, watercrafts, and flying objects.

In the first aspect, the second device may include an electric component configured to run on direct current (DC) power. DC power is generated when hydrogen as an energy source is converted into electric power. Therefore, the DC power converted from hydrogen by a hydrogen power generator etc. can be used as it is in the second device. This can reduce power loss as compared to the case where the DC power is converted to alternating current (AC) power and used.

In the first aspect, the other energy source may be a general electric power system. According to such a configuration, the second device can reliably receive power supply from the general electric power system even when the supply of hydrogen from the hydrogen cartridge is cut off.

In the first aspect, the second device may include a charging circuit for a battery. In this case, the charging circuit may be configured to charge the battery by using the hydrogen cartridge and the other energy source as an energy source. According to such a configuration, a battery for a separate electric device that is attachable to and detachable from the second device can be charged with the power obtained by using the hydrogen cartridge as an energy source.

In the first aspect, the second device may include an electric device configured to operate using the battery as a power source. According to such a configuration, the power obtained by using the hydrogen cartridge as an energy source can be stored in the battery, and the second device can be operated even when the hydrogen cartridge is removed from the second device.

In the first aspect, the hydrogen utilization system may further include a notification device configured to externally notify a replacement timing of the hydrogen cartridge attached to the first device. In this case, the replacement timing of the hydrogen cartridge may be notified to a user of the first device, or may be notified to a business operator who provides the hydrogen cartridge to the user, although the present disclosure is not particularly limited to these. In other embodiments, the user of the first device may not need the notification and may replace the hydrogen cartridge at any desired timing.

In the first aspect, the notification device may be configured to externally notify the replacement timing according to a period of use of the hydrogen cartridge attached to the first device. The amount of hydrogen remaining in the hydrogen cartridge generally depends on the period of use of the hydrogen cartridge. Therefore, the replacement timing of the hydrogen cartridge can be determined according to the period of use of the hydrogen cartridge without necessarily measuring the amount of hydrogen remaining in the hydrogen cartridge.

In the first aspect, the notification device may be configured to externally notify the replacement timing according to the amount of hydrogen remaining in the hydrogen cartridge attached to the first device. According to such a configuration, the replacement timing of the hydrogen cartridge can be accurately determined based on the amount of hydrogen remaining in the hydrogen cartridge. The amount of hydrogen remaining in the hydrogen cartridge attached to the first device may be directly measured by a sensor etc., or may be estimated according to the amount of energy consumed by the first device, etc.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows the configuration of a hydrogen utilization system according to an embodiment.

### DETAILED DESCRIPTION OF EMBODIMENTS

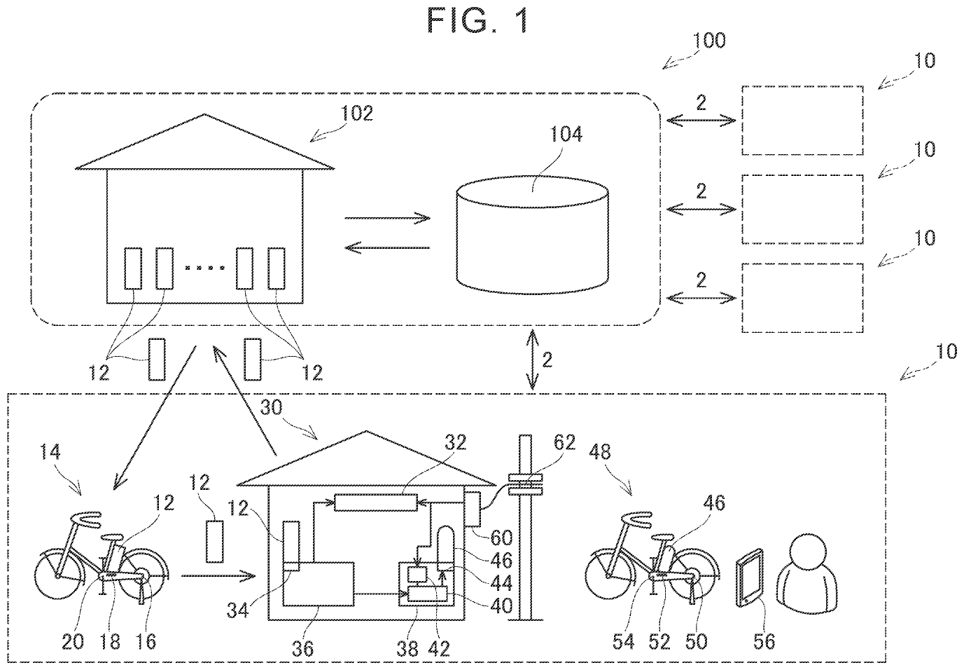

A hydrogen utilization system 10 according to an embodiment will be described with reference to the drawings. The hydrogen utilization system 10 according to the present embodiment is a system that utilizes hydrogen as an energy source for at least one device 14, 32, 36, 38. As shown in FIG. 1, the hydrogen utilization system 10 includes at least one hydrogen cartridge 12. The hydrogen cartridge 12 is a container storing hydrogen, and can be attached to and detached from each device 14, 32, 36, 38. That is, hydrogen is supplied to the hydrogen utilization system 10 by using the hydrogen cartridge 12. As shown in FIG. 1, the hydrogen utilization system 10 is connected to a hydrogen provision system 100 via a communication network 2 such as the Internet so that the hydrogen utilization system 10 can communicate with the hydrogen provision system 100.

The hydrogen provision system 100 is a system that provides hydrogen to the hydrogen utilization system 10 by using the hydrogen cartridge 12. The hydrogen provision system 100 provides the hydrogen cartridge 12 filled with hydrogen to the hydrogen utilization system 10, and collects the used hydrogen cartridge 12 from the hydrogen utilization system 10. The collected hydrogen cartridge 12 is refilled in the hydrogen provision system 100 and is provided to the hydrogen utilization system 10 again. That is, the hydrogen cartridge 12 is repeatedly used between the hydrogen utilization system 10 and the hydrogen provision system 100.

The hydrogen provision system 100 may be operated by a business operator, and the hydrogen utilization system 10 may be used by a user who has a contract with the business operator, although the present disclosure is not particularly limited to this. In this case, the contract between the business operator and the user may be either a subscription contract in which the hydrogen cartridge 12 is replaced regularly, or a one-time contract in which the hydrogen cartridge 12 is replaced as needed. Part or all of the hydrogen utilization system 10 may be owned by the user, or may be rented to the user by the business operator.

As described above, the hydrogen cartridge 12 is a container storing hydrogen. The hydrogen cartridge 12 contains a hydrogen storage alloy in its housing. A hydrogen storage alloy is a substance capable of absorbing and releasing hydrogen. The hydrogen cartridge 12 can store hydrogen in the hydrogen storage alloy, and can supply the hydrogen to the outside when needed. The hydrogen cartridge 12 according to the present embodiment can be attached to and detached from the devices 14, 32, 36, and 38 included in the hydrogen utilization system 10. The hydrogen cartridge 12 is attached to the devices 14, 32, 36, and 38 to supply hydrogen that is an energy source to the devices 14, 32, 36, and 38. The shape, size, etc. of the hydrogen cartridge 12 are not particularly limited.

As shown in FIG. 1, the hydrogen utilization system 10 includes a hydrogen-assisted bicycle 14 as one of the devices 14, 32, 36, and 38. The hydrogen-assisted bicycle 14 includes: a drive motor 16 that drives wheels; a cartridge port 18 to and from which the hydrogen cartridge 12 can be attached and detached; and a hydrogen power generation system 20 connected to the cartridge port 18. The hydrogen power generation system 20 generates power using hydrogen supplied from the hydrogen cartridge 12, and supplies the generated power to the drive motor 16 according to the user's pedal operation. The user of the hydrogen-assisted bicycle 14 can thus be assisted by the drive motor 16 in stepping on pedals. In other embodiments, the hydrogen utilization system 10 may include other types of mobility devices such as other vehicles like a scooter, watercrafts, and flying objects, instead of or in addition to the hydrogen-assisted bicycle 14.

As shown in FIG. 1, the hydrogen utilization system 10 further includes a home appliance 32, a hydrogen power generator 36, and charging equipment 38. The home appliance 32, the hydrogen power generator 36, and the charging equipment 38 are installed in an ordinary home 30. Each of the home appliance 32 and the charging equipment 38, together with the hydrogen power generator 36, forms one of the devices 14, 32, 36, and 38. The ordinary home 30 herein refers to a residential building such as an apartment or a house. The ordinary home 30 is equipped with a cartridge port 34 to and from which the hydrogen cartridge 12 can be attached and detached, and the hydrogen power generator 36 connected to the cartridge port 34. The hydrogen power generator 36 generates power using hydrogen supplied from the hydrogen cartridge 12 as an energy source, and supplies the generated power to the home appliance 32 and the charging equipment 38. The hydrogen power generator 36 may be, for example, a fuel cell system. In other embodiments, the hydrogen utilization system 10 may be used in places of business (e.g., offices, factories, and hospitals) etc. instead of the ordinary home 30.

The home appliance 32 is electrically connected to the hydrogen power generator 36, and is configured to run on power generated by the hydrogen power generator 36. The home appliance 32 is also electrically connected to a general electric power system 62 via a distribution board 60, and is configured to run also on power supplied from the general electric power system 62. Therefore, even if the supply of hydrogen from the hydrogen cartridge 12 to the hydrogen power generator 36 is cut off and therefore the supply of power from the hydrogen power generator 36 to the home appliance 32 is cut off, the home appliance 32 can continue to operate with the power supplied from the general electric power system 62. The home appliance 32 may be, but is not limited to, a lighting fixture, a refrigerator, a washing machine, or an air conditioner. Typically, the home appliance 32 is a device that runs on alternating current (AC) power. Therefore, in the case where the hydrogen power generator 36 generates direct current (DC) power, an inverter that converts DC power to AC power can be provided between the hydrogen power generator 36 and the home appliance 32.

In other embodiments, the home appliance 32 may be a device that runs on DC power, such as a light-emitting diode (LED). In this case, the DC power converted from hydrogen by the hydrogen power generator 36 can be used as it is. This can reduce power loss as compared to the case where the DC power is converted to AC power and used. The charging equipment 38 is a device for charging an external battery 46.

The charging equipment 38 includes a charging circuit 40, a converter 42 that converts AC power to DC power, and a battery port 44 electrically connected to the charging circuit 40. The external battery 46 can be attached to and detached from the battery port 44. The charging circuit 40 can charge the external battery 46 attached to the battery port 44 with the power supplied from the hydrogen power generator 36. In the case where the hydrogen power generator 36 generates DC power, the charging circuit 40 can supply the DC power to the external battery 46 without converting it to AC power.

The charging equipment 38 is also electrically connected to the general electric power system 62 via the distribution board 60, and can also charge the external battery 46 with the power supplied from the general electric power system 62. Typically, the power supplied from the general electric power system 62 is AC power. The AC power supplied from the general electric power system 62 is converted to DC power by the converter 42 in the charging equipment 38 and then supplied to the external battery 46. Therefore, even if the supply of power from the hydrogen power generator 36 to the charging equipment 38 is cut off, the charging equipment 38 can charge the external battery 46 with the power supplied from the general electric power system 62.

The external battery 46 is a power source for an electric device 48. After the external battery 46 is charged, the external battery 46 is detached from the charging equipment 38 and attached to the electric device 48. The external battery 46 used for the electric device 48 can be attached again to the battery port 44 of the charging equipment 38 for recharging. The electric device 48 may be, but is not particularly limited to, a battery-assisted bicycle 48. The battery-assisted bicycle 48 includes: a drive motor 50 that drives wheels; a battery port 52 to and from which the external battery 46 can be attached and detached; and a control device 54. The control device 54 supplies power from the external battery 46 to the drive motor 50 according to the user's pedal operation. The user of the battery-assisted bicycle 48 can thus be assisted by the drive motor 50 in stepping on pedals. In other embodiments, the hydrogen utilization system 10 may include other types of mobility devices or non-mobility devices, such as other vehicles like a scooter, watercrafts, and flying objects, instead of or in addition to the battery-assisted bicycle 48.

As shown in FIG. 1, the hydrogen utilization system 10 further includes a communication device (notification device) 56. The communication device 56 may be, for example, a mobile terminal (e.g., a smartphone) owned by the user of the hydrogen utilization system 10. The communication device 56 is connected to the hydrogen-assisted bicycle 14 and the hydrogen power generator 36 so that the communication device 56 can communicate with the hydrogen-assisted bicycle 14 and the hydrogen power generator 36. In other embodiments, the communication device 56 may be rented to the user by a business operator.

Next, the hydrogen provision system 100 will be described. As shown in FIG. 1, the hydrogen provision system 100 includes a hydrogen filling facility 102 and a server 104. The hydrogen filling facility 102 is a device that provides, collects, and refills the hydrogen cartridges 12. The server 104 is configured to communicate with the communication device 56 owned by the user of the hydrogen utilization system 10. The server 104 can give various instructions to the hydrogen filling facility 102 based on information the server 104 sends to and receive from the communication device 56.

As an example, the hydrogen power generation system 20 of the hydrogen-assisted bicycle 14 measures the period of use of the hydrogen cartridge 12. As used herein, the “period of use of the hydrogen cartridge 12” refers to the elapsed time since the hydrogen cartridge 12 was attached to the cartridge port 18. This elapsed time may include the period during which the hydrogen-assisted bicycle 14 is not in use, or may include only the time during which the hydrogen-assisted bicycle 14 is actually used. The hydrogen power generation system 20 sends a predetermined notification to the communication device 56 when the period of use of the hydrogen cartridge 12 reaches a predetermined period. In response to the predetermined notification, the communication device 56 sends a predetermined delivery request to the server 104 of the hydrogen provision system 100. In response to a predetermined delivery request, the server 104 instructs the hydrogen filling facility 102 to deliver a hydrogen cartridge 12 to the hydrogen utilization system 10. A hydrogen cartridge 12 filled with hydrogen is thus delivered from the hydrogen provision system 100 to the hydrogen utilization system 10.

The hydrogen cartridge 12 attached to the hydrogen-assisted bicycle 14 is replaced with the hydrogen cartridge 12 delivered to the hydrogen utilization system 10. The hydrogen cartridge 12 attached to the hydrogen power generator 36 is replaced with the hydrogen cartridge 12 removed from the hydrogen-assisted bicycle 14. Hydrogen remaining in the hydrogen cartridge 12 is thus used in the hydrogen power generator 36. The hydrogen cartridge 12 removed from the hydrogen power generator 36 is returned to the hydrogen filling facility 102 of the hydrogen provision system 100 and is refilled with hydrogen. At this time, the hydrogen cartridge 12 removed from the hydrogen power generator 36 may have completely run out of hydrogen. However, the home appliance 32 and the charging equipment 38 that receive power supply from the hydrogen power generator 36 can also receive power supply from the general electric power system 62. Therefore, the home appliance 32 and the charging equipment 38 can continue to operate even if the hydrogen cartridge 12 of the hydrogen power generator 36 runs out of hydrogen.

With the above configuration, the hydrogen cartridge 12 containing the hydrogen storage alloy can be used as an energy source for the hydrogen-assisted bicycle 14, the home appliance 32, the hydrogen power generator 36, and the charging equipment 38. At least the home appliance 32 and the charging equipment 38 can operate not only with the hydrogen cartridge 12 but also with the power from the general electric power system 62. According to such a configuration, the hydrogen cartridge 12 can first be used for the hydrogen-assisted bicycle 14, and can be replaced at any desired timing. This replacement timing may be a relatively early timing in order to avoid the hydrogen-assisted bicycle 14 running out of hydrogen. The used hydrogen cartridge 12 of the hydrogen-assisted bicycle 14 can then be attached to the hydrogen power generator 36 for reuse. Even if the supply of hydrogen from the hydrogen cartridge 12 is unintentionally cut off, the home appliance 32 and the charging equipment 38 can continue to operate with the power from the general electric power system 62. Therefore, the hydrogen power generator 36 connected to the home appliance 32 and the charging equipment 38 can continue to use the hydrogen cartridge 12 until the amount of hydrogen remaining in the hydrogen cartridge 12 becomes zero.

In the above embodiment, the replacement timing of the hydrogen cartridge 12 attached to the hydrogen-assisted bicycle 14 is determined according to the period of use of the hydrogen cartridge 12. However, the replacement timing of the hydrogen cartridge 12 may be determined by other methods. For example, in other embodiments, the replacement timing may be determined according to the amount of hydrogen remaining in the hydrogen cartridge 12 attached to the hydrogen-assisted bicycle 14. In this case, the amount of hydrogen remaining in the hydrogen cartridge 12 may be directly measured by a sensor etc., or may be estimated according to the amount of energy consumed by the hydrogen-assisted bicycle 14, etc. With such a configuration, the replacement timing of the hydrogen cartridge 12 can be accurately determined based on the amount of hydrogen remaining in the hydrogen cartridge 12.

In the above embodiment, the hydrogen utilization system 10 includes the communication device 56 that externally notifies the replacement timing of the hydrogen cartridge 12 attached to the hydrogen-assisted bicycle 14. However, the hydrogen utilization system 10 need not necessarily include the communication device 56. As an example, the replacement timing of the hydrogen cartridge 12 attached to the hydrogen-assisted bicycle 14 may be directly notified to the server 104 of the hydrogen provision system 100.

The hydrogen-assisted bicycle 14 in the present specification is an example of the first device in the present technique. The combination of the hydrogen power generator 36 and the home appliance 32 and the combination of the hydrogen power generator 36 and the charging equipment 38 in the present specification are examples of the second device in the present technique. As described above, the second device may be implemented by two or more devices, namely a combination of a device to and from which the hydrogen cartridge 12 can be attached and detached and that is operable using the hydrogen cartridge 12 as an energy source and a device that is also operable with another energy source. In other embodiments, the second device may be implemented by one device. The combination of the hydrogen power generator 36, the charging equipment 38, and the battery-assisted bicycle 48 in the present specification is also an example of the second device in the present technique. In this case, the battery-assisted bicycle 48 is an example of the electric device configured to operate using a battery as a power source. The communication device 56 in the present specification is an example of the notification device in the present technique.

In the present specification, “being operable using the hydrogen cartridge 12 as an energy source” includes being operable with the power obtained by power generation using hydrogen in the hydrogen cartridge 12, and being operable with the energy obtained by burning hydrogen in the hydrogen cartridge 12.

Although some specific examples are described in detail above, these are merely illustrative, and are not intended to limit the scope of the claims. The technique described in the claims includes various modifications and variations of the specific examples illustrated above. The technical elements described in the present specification or illustrated in the drawings exhibit technical utility alone or in combinations.

What is claimed is:

1. A hydrogen utilization system comprising:
a hydrogen cartridge containing a hydrogen storage alloy;
a first device configured in such a manner that the hydrogen cartridge is attachable to and detachable from the first device, the first device being operable using the hydrogen cartridge as an energy source; and
a second device configured in such a manner that the hydrogen cartridge is attachable to and detachable from the second device, the second device being operable using the hydrogen cartridge as an energy source and being operable using another energy source.

2. The hydrogen utilization system according to claim 1, wherein the first device is a mobility device, and the second device is a non-mobility device.

3. The hydrogen utilization system according to claim 1, wherein the second device includes an electric component configured to run on direct current power.

4. The hydrogen utilization system according to claim 1, wherein the other energy source is a general electric power system.

5. The hydrogen utilization system according to claim 1, wherein:
the second device includes a charging circuit for a battery; and
the charging circuit is configured to charge the battery by using the hydrogen cartridge and the other energy source as an energy source.

6. The hydrogen utilization system according to claim 5, wherein the second device includes an electric device configured to operate using the battery as a power source.

7. The hydrogen utilization system according to claim 2, the hydrogen utilization system further comprising a notification device configured to externally notify a replacement timing of the hydrogen cartridge attached to the first device.

8. The hydrogen utilization system according to claim 7, wherein the notification device is configured to externally notify the replacement timing according to a period of use of the hydrogen cartridge attached to the first device.

9. The hydrogen utilization system according to claim 7, wherein the notification device is configured to externally notify the replacement timing according to an amount of hydrogen remaining in the hydrogen cartridge attached to the first device.
